(19) United States
(12) Patent Application Publication
(10) Pub. No.: US 2002/0003458 A1
(43) Pub. Date: Jan. 10, 2002

(54) PHASE SHIFTER ARRANGEMENT

(76) Inventor: GANG XU, VICTORIA (AU)

Correspondence Address: SUGHRUE MION ZINN MACPEAK & SEAS PLLC, 2100 PENNSYLVANIA AVENUE N W, WASHINGTON, DC, 200373213

(21) Appl. No.: 09/271,866

(22) Filed: Mar. 18, 1999

(30) Foreign Application Priority Data
Mar. 18, 1998 (AU) PP 2419
Feb. 1, 1999 (AU) 14278/99

(51) Int. Cl. H01P 1/18

(52) U.S. Cl. 333/161; 333/139

(57) ABSTRACT

This invention discloses an adjustable, relatively small phase-shiftable network for an antenna array, which can be incorporated into a PCB distribution network.

The network comprises a PCB distribution element (A) comprising a planar dielectric circuit board (2) supporting a pattern of conductive tracks (3). The conductive tracks and the dielectric circuit board form a transmission line network which splits a signal applied to a signal input terminal (I) into three paths that terminate respectively in three terminals (T, B and C) for feeding the input signal to Top (T), Bottom (B) and Centre (C) sections of a antenna array. The distribution element (A) is supported in a spaced relationship with a conductive ground plane (B). A moveable planar dielectric element (C) having a series of teeth (4, 5) along opposite edges, is slidably mounted over the top surface of the distribution element (A). The moveable dielectric element (C) is supported in a slidable manner by two rods (6, 7) attached to the ground plane (B). By moving the dielectric element, the phases in the top and bottom sections of the antenna array are changed in opposite directions so that the phase shift in one section is increased and the other section is decreased, which causes the radiating beam to tilt.

This invention relates to antennas and in particular to an arrangement to electrically down-tilt the electromagnetic wave pattern associated with a transmit antenna array, or electrically re-orient a receive antenna array.

It is sometimes desirable to adjust the orientation of the electromagnetic wave pattern of a transmit antenna array, particularly a downward adjustment, typically 0° to 15° below horizontal, when the antenna is located at a higher altitude than other antennas that communicate with the transmit antenna array. The downward adjustment of the radiation pattern alters the coverage area and may enhance communication with mobile users situated in shadowed areas below the transmit antenna array.

Besides actually mechanically tilting the entire antenna assembly, it is known to electrically down tilt the radiation pattern by controllably varying the relative phase/s between two or more radiating elements of the antenna array.

One known method by which the relative phase between two or more radiating elements can be changed is to change the relative lengths of respective transmission lines connecting the antenna's common feed point to each element of the antenna array. Typically, various predetermined lengths of jumper cable are provided which are selectively connected between the common feed and each element to obtain a desired down-tilt. The jumper cables include co-axial connectors to facilitate connection. Furthermore, if stripline is used to connect the common feed point to the respective elements of the antenna array, some form of transition means is required to couple the jumper cable's co-axial connections to the strip line. A disadvantage of this known method is that it is relatively expensive, less reliable and susceptible to the generation of intermodulation products.

Another known method by which the relative phase between two or more radiating elements can be changed is to change the propagation velocity of the transmission line connecting the common feed point to at least some of the elements of the antenna array. Typically, this latter method is achieved by selectively changing the dielectric constant of the transmission line dielectric. If the transmission line is in the form of a conductive strip, the propagation velocity thereof is changed by introducing a dielectric material between the strip and its associated ground plane.

It is, however, well understood that the introduction of dielectric material under such a conductive strip causes the strip's normal impedance to be disturbed. For example, if a conductive strip having a certain width is spaced above a ground-plane at a certain distance such as to present a 50 ohm impedance, the introduction of dielectric material between the conductive strip and the ground-plane will reduce the value of this impedance to a value that depends upon the effective dielectric constant of the dielectric material. The resulting impedance mismatch would cause a degradation of return-loss performance of the antenna array.

Australian Patent No. 664625 discloses an arrangement of an adjustable phase shifter comprising dielectric phase shifter elements moveably interposed between conductive strips that couple radiating elements, and a common ground plane. The phase shifter elements are of a characteristic configuration which avoids disturbing the normal impedance during adjustment. This known arrangement, however, requires that respective phase shifter elements be located between each active strip line and the conductive ground plane. Such an arrangement imposes constructional disadvantages as well as limitations to the range of phase shift produced, which consequently imposes limits to the range of tilt.

It is an object of the present invention to provide an adjustable phase shifter arrangement of improved simplicity and compactness.

It is a further object of the present invention to provide an adjustable phase-shifter arrangement which allows a single phase-shifter element of relatively small dimensions to adjust the electrical beam tilt of a multi-element antenna array in a simple manner.

It is still a further object of the invention to provide a phase-shifter arrangement which allows a relatively wide range of phase shift.

According to a first aspect of the invention there is provided a phase shifter element comprising a substantially planar conductor means arranged to form at least one signal path, the or each path including a signal input means at one end thereof, a signal output means at the other end thereof and an intermediate section of conductor, said conductor means being supported in a substantially parallel relationship with a conductive ground plane member, wherein said phase shifter element further includes a planar dielectric member adjacent said conductor means such that the conductor means is between the plane of the dielectric member and the ground plane, and a variable adjustment means arranged to selectively produce relative movement between the conductor means and the planar dielectric member in a direction which traverses said intermediate section of the conductor means, the phase of a signal at the output of the or each said signal output means being determined by the extent to which the planar dielectric member overlaps said conductor means, such overlap being varied by said movement.

According to a second aspect of the invention, there is provided a phase shifter element comprising a transmission line means formed by a planar first dielectric member having a first surface opposite a second surface, said first surface supporting thereon a pattern of at least one conductive track arranged to form a signal path of a predetermined physical length, the or each path including a signal input means at one end thereof, a signal output means at the other end thereof and an intermediate section of conductive track, said transmission line means being supported in a substantially parallel relationship with a conductive ground plane member, said ground plane member being spaced from or contiguous with said dielectric member's second surface, wherein said phase shifter element further includes a second planar dielectric member adjacent said first surface of said first dielectric member, and variable adjustment means arranged to selectively produce relative movement between the first and second dielectric members in a direction which traverses said intermediate section of conductive track, the phase of a signal at the output of the or each said signal output means being determined by the extent to which said second dielectric member overlaps said pattern of said conductive track(s), such overlap being varied by said movement.

According to a third aspect of the invention there is provided a phase shifter element comprising a transmission line means formed by a planar first dielectric member having a first surface opposite a second surface, said first surface supporting thereon a pattern of at least one conductive track arranged to form a signal path of a predetermined physical length, the or each path including a signal input means at one end thereof, a signal output means at the other end thereof and an intermediate section of conductive track, said transmission line means being supported in a substantially parallel relationship with a conductive ground plane member, said ground plane member being spaced from or contiguous with said dielectric member's second surface, wherein said phase shifter element further includes a second planar dielectric member adjacent said first surface of said first dielectric member, said second planar dielectric member including at least two opposite edges, and variable adjustment means arranged to selectively produce relative linear movement between the first and second dielectric members in a direction which is transverse said intermediate section of conductive track, the phase of a signal at the output of the or each said signal output means being determined by the extent to which said second dielectric member overlaps said pattern of said conductive track(s), such overlap being varied by said linear movement.

Preferably, the variable adjustment means comprises an arrangement of said second planar dielectric member slidably fixed adjacent said first surface of said first planar dielectric member, the phase of a signal at the or each said signal output means being determined by the extent to which said second planar dielectric member overlaps said pattern of said conductive track(s), such overlap extent being varied by linear movement of said second planar dielectric member.

In order that the invention may be readily carried into effect, an embodiment thereof will now be described in relation to figures of the accompanying drawings, in which:

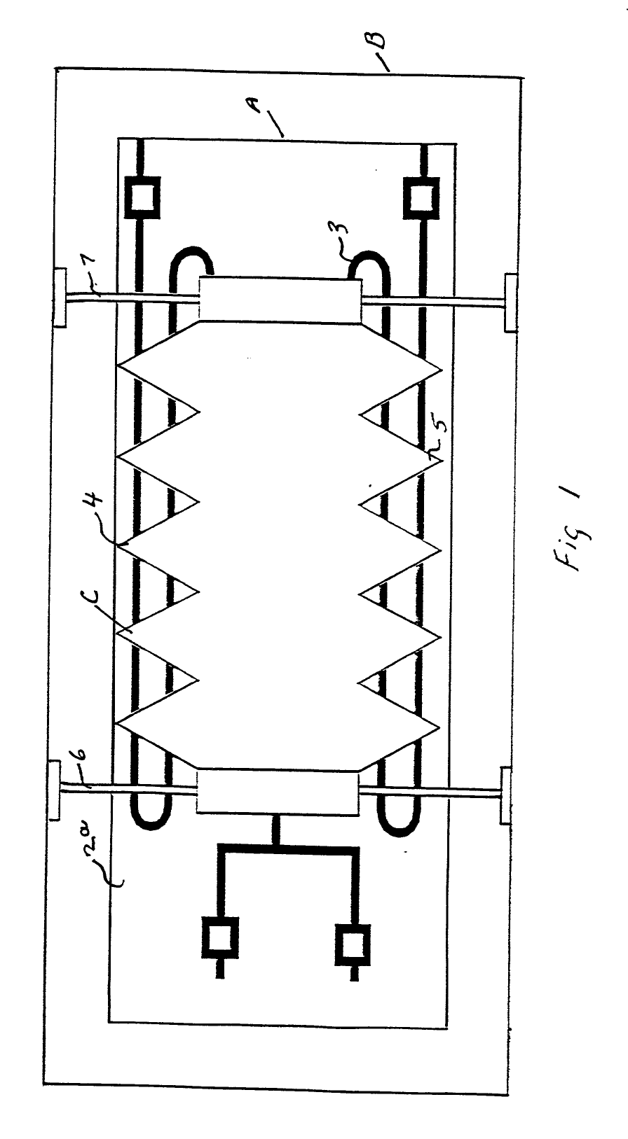

FIG. 1 is a top view of a first embodiment of the phase-shifter arrangement of the present invention.

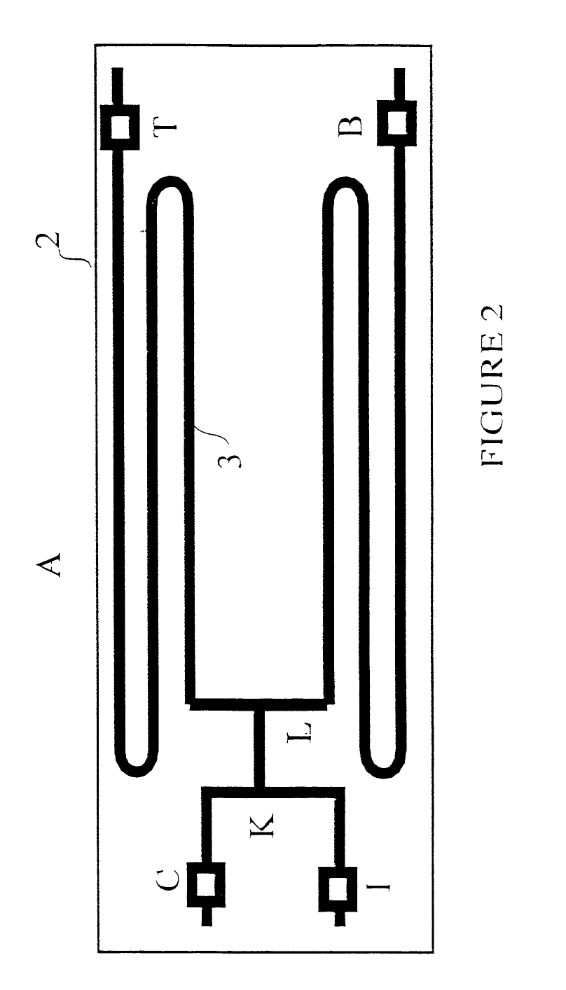

FIG. 2 is a top view of a printed circuit board (PCB), distribution element incorporated in the phase-shifter arrangement shown in FIG. 1.

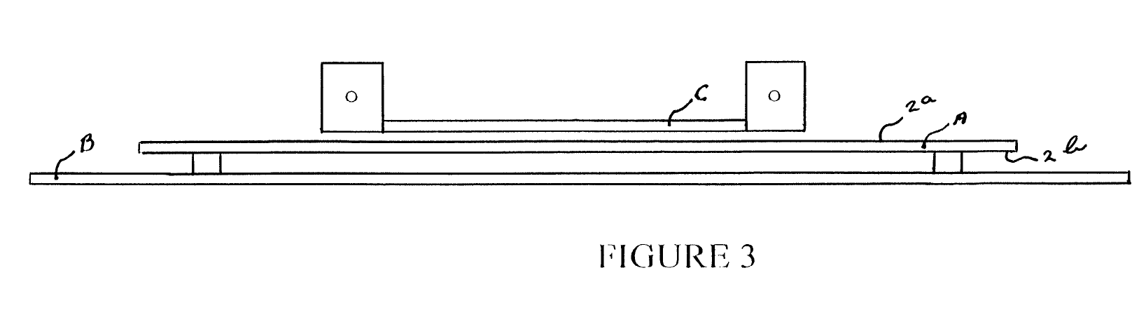

FIG. 3 is a side view of the phase-shifter arrangement shown in FIG. 1.

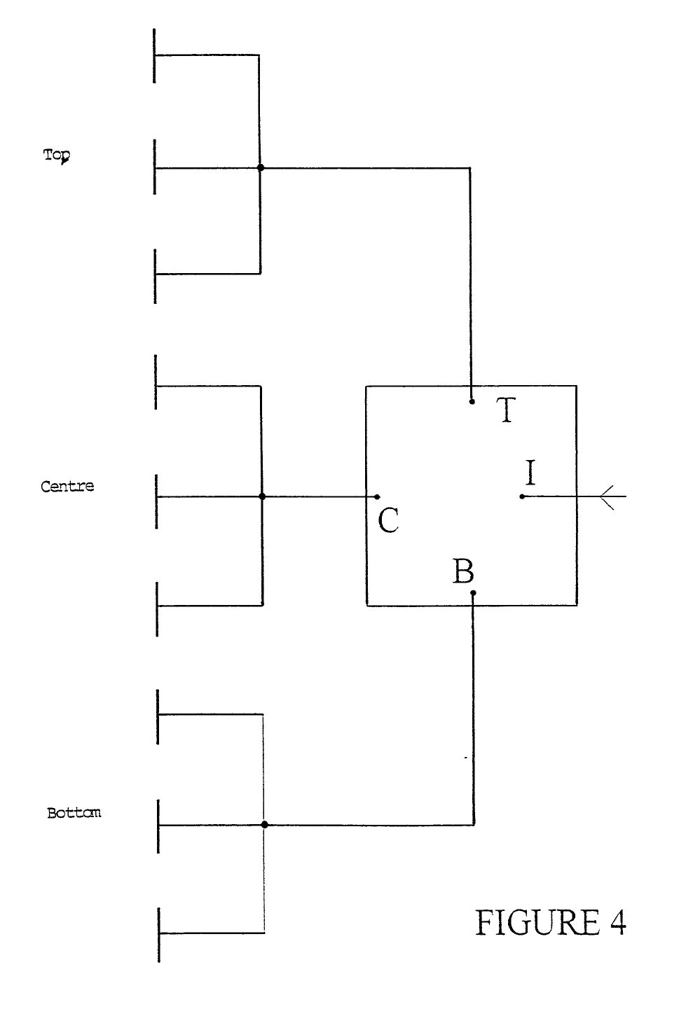

FIG. 4 is a schematic layout of an antenna array incorporating the phase-shifter shown in FIG. 1.

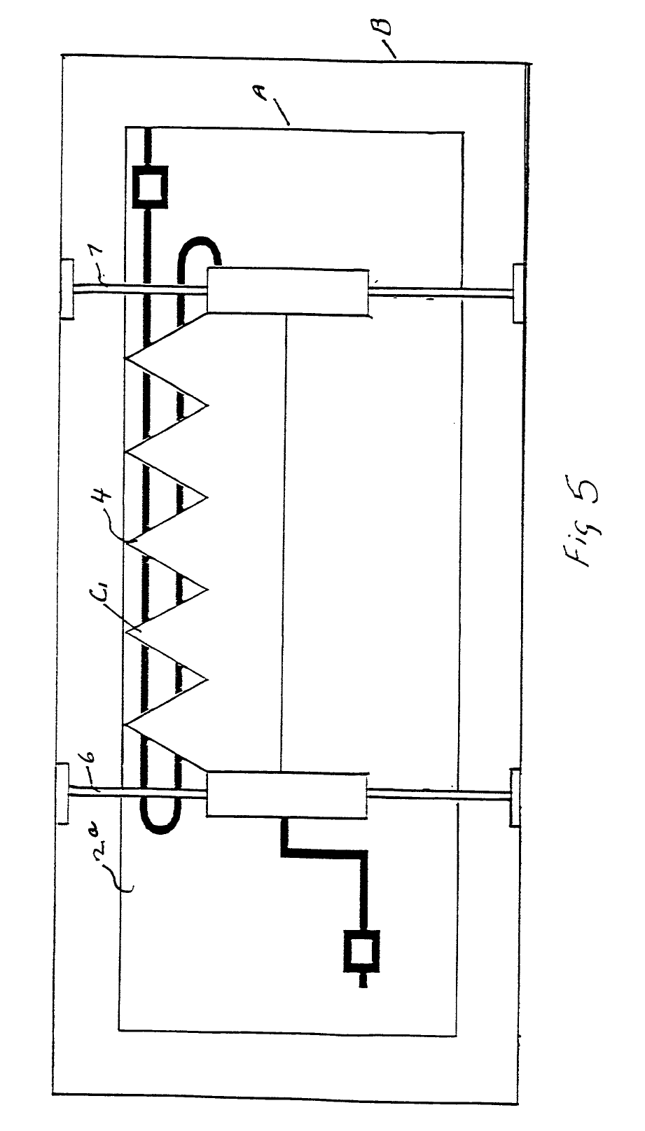

FIG. 5 shows a top view of a second embodiment of the phase-shifter arrangement of the present invention.

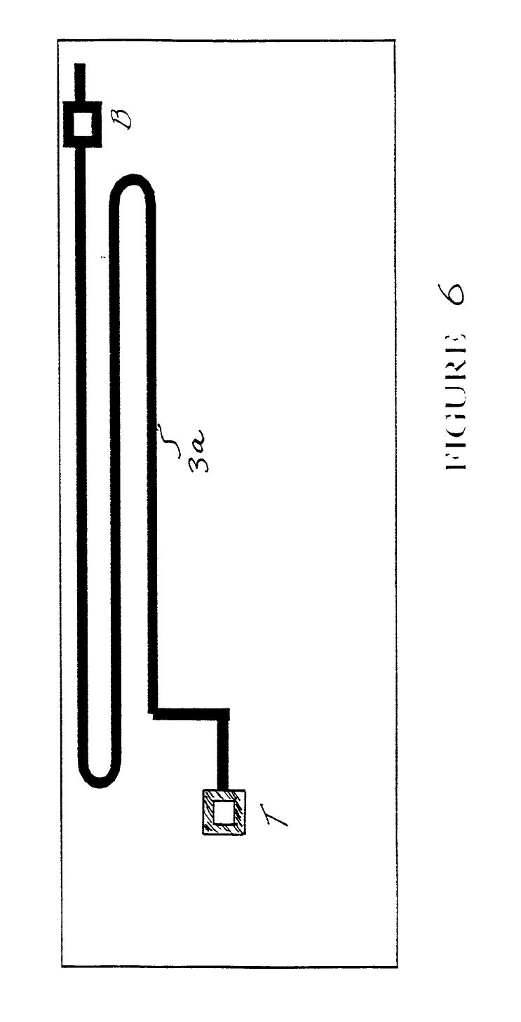

FIG. 6 shows a top view of a PCB element incorporated in the phase-shifter arrangement shown in FIG. 5.

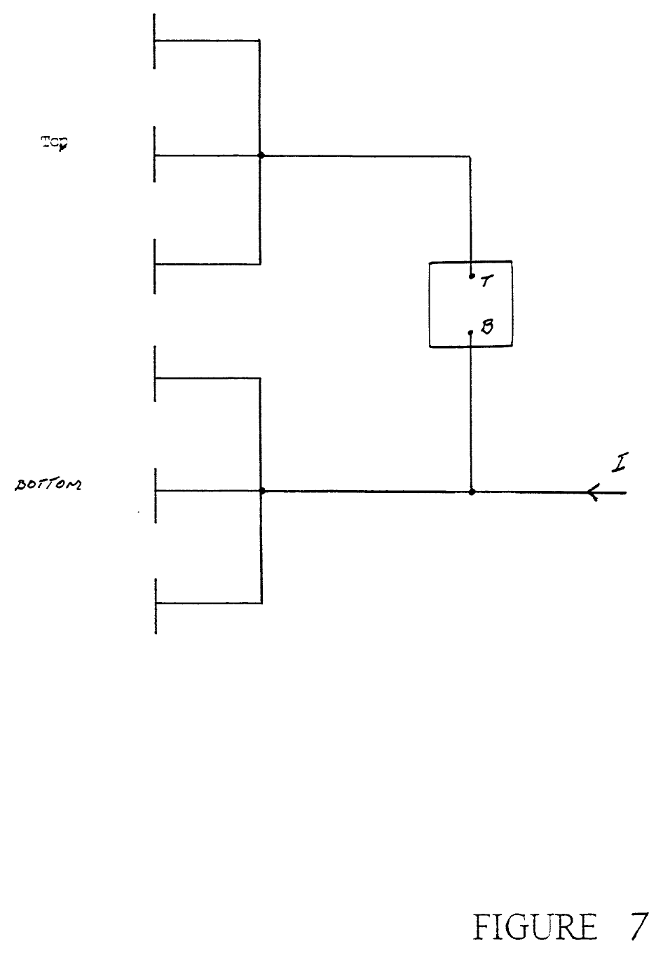

FIG. 7 is a schematic layout of an antenna array incorporating the phase-shifter arrangement shown in FIG. 5.

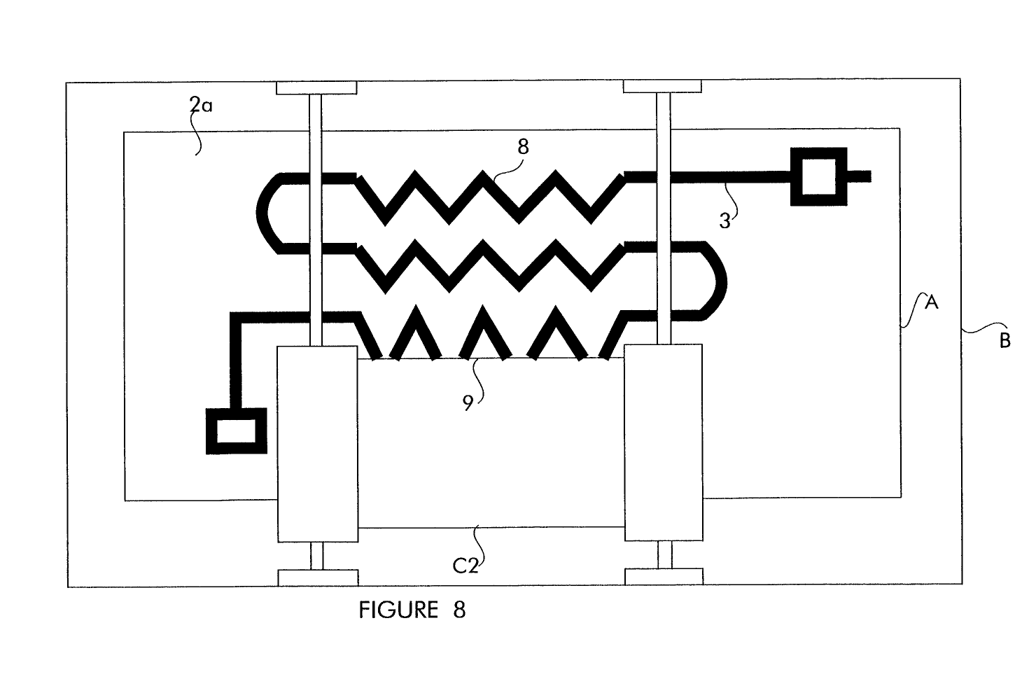

FIG. 8 is a top view of a third embodiment of the phase-shifter arrangement of the present invention.

Referring to FIGS. 1-4 of the drawings, there is shown a PCB distribution element (A) comprising a planar dielectric circuit board (2) supporting a pattern of conductive tracks (3) on a first surface 2a thereof. The conductive tracks and the dielectric circuit board form a transmission line network for splitting a signal applied to a signal input terminal (I) into three paths that terminate respectively in three terminals (T, B and C) for feeding the input signal to the Top (T), Bottom (B) and Centre (C) sections of an antenna array (see FIG. 4). The distribution element (A) is supported in a spaced relationship with a conductive ground plane (B); the planar dielectric circuit board's (2) second surface (2b) and the ground plane facing one another.

Alternately, the second surface (2b) of the said circuit board and the ground plane can be contiguous (not shown).

A moveable planar dielectric element (C) having a series of teeth (4,5) along opposite edges, is slidably mounted and adjacent to the top surface of the distribution element (A). The moveable dielectric element (C) is supported in a linear slidable manner by two parallel rods (6,7) attached to the ground plane (B). It will be understood that a rotational arrangement of a dielectric element could be adapted, and is envisaged.

By selectively moving the dielectric element, the phases in the top and bottom sections of the antenna array are changed in opposite directions so that the phase in one section is increased and in the other section is decreased, which causes the radiating beam to tilt.

Referring to FIGS. 5-7 of the drawings there is shown a second embodiment of the invention for use with a two section antenna array (FIG. 7). The phase-shifter arrangement of this embodiment is similar to the one described in relation to FIGS. 1 -4, except that only a single elongated, serpentine conductive track 3a is provided to form a transmission line whose distal ends terminate at respective terminals T and B. A moveable dielectric element C1 is in the form of a bisected dielectric element shown in FIG. 1. It will be understood that a rotational arrangement of the dielectric element could be adapted for the arrangement shown in FIG. 5.

Referring to FIG. 8, there is shown an embodiment which, instead of using a series of teeth along edges of the movable planar dielectric element (C1), as shown, for example, in FIG. 5, an electrically equivalent configuration is used. This is achieved by providing the conductive tracks 3 with a non-linear portion in the form of a meandering pattern 8 of a triangular configuration. Other configurations, such as, for example, trapezoid or semi-ellipsoid could be adapted. In the embodiment shown in FIG. 8, the movable dielectric element C1 is provided with a straight edge 9.

The claims defining the invention are as follows:

1. A phase shifter element comprising a substantially planar conductor means arranged to form at least one signal path, the or each path including a signal input means at one end thereof, a signal output means at the other end thereof and an intermediate section of conductor, said conductor means being supported in a substantially parallel relationship with a conductive ground plane member, wherein said phase shifter element further includes a planar dielectric member adjacent said conductor means such that the conductor means is between the plane of the dielectric member and the ground plane, and a variable adjustment means arranged to selectively produce relative movement between the conductor means and the planar dielectric member in a direction which traverses said intermediate section of the conductor means, the phase of a signal at the output of the or each said signal output means being determined by the extent to which the planar dielectric member overlaps said conductor means, such overlap being varied by said movement.

2. A phase shifter element comprising a transmission line means formed by a planar first dielectric member having a first surface opposite a second surface, said first surface supporting thereon a pattern of at least one conductive track arranged to form a signal path of a predetermined physical length, the or each path including a signal input means at one end thereof, a signal output means at the other end thereof and an intermediate section of conductive track, said transmission line means being supported in a substantially parallel relationship with a conductive ground plane member, said ground plane member being spaced from or contiguous with said dielectric member's second surface, wherein said phase shifter element further includes a second planar dielectric member adjacent said first surface of said first dielectric member, and variable adjustment means arranged to selectively produce relative movement between the first and second dielectric members in a direction which traverses said intermediate section of conductive track, the phase of a signal at the output of the or each said signal output means being determined by the extent to which said second dielectric member overlaps said pattern of said conductive track(s), such overlap being varied by said movement.

3. A phase shifter element comprising a transmission line means formed by a planar first dielectric member having a first surface opposite a second surface, said first surface supporting thereon a pattern of at least one conductive track arranged to form a signal path of a predetermined physical length, the or each path including a signal input means at one end thereof, a signal output means at the other end thereof and an intermediate section of conductive track, said transmission line means being supported in a substantially parallel relationship with a conductive ground plane member, said ground plane member being spaced from or contiguous with said dielectric member's second surface, wherein said phase shifter element further includes a second planar dielectric member adjacent said first surface of said first dielectric member, said second planar dielectric member including at least two opposite edges, and variable adjustment means arranged to selectively produce relative linear movement between the first and second dielectric members in a direction which is transverse said intermediate section of conductive track, the phase of a signal at the output of the or each said signal output means being determined by the extent to which said second dielectric member overlaps said pattern of said conductive track(s), such overlap being varied by said linear movement.

4. A phase shifter element as claimed in claim 3, wherein said variable adjustment means comprises an arrangement of said second planar dielectric member slidably fixed adjacent said first surface of said first planar dielectric member, the phase of a signal at the or each said signal output means being determined by the extent to which said second planar dielectric member overlaps said pattern of said conductive track(s), such overlap extent being varied by linear movement of said second planar dielectric member.

5. A phase shifter element as claimed in claim 4, wherein said second planar dielectric member includes a plurality of extension members extending from at least one said edge thereof.

6. A phase shifter element as claimed in claim 5, wherein said second planar dielectric member includes a plurality of extension members extending from each of said two opposite edges of the second planar dielectric member.

7. A phase shifter element as claimed in claim 5 or 6, wherein said plurality of extension members comprise at least two triangular-shaped extensions.

8. A phase shifter element as claimed in claim 4, wherein the intermediate section of the or each conductive track includes a non-linear portion in the form of a meandering pattern.

9. A phase shifter element as claimed in claim 8, wherein said meandering pattern is a sawtooth configuration.

10. A phase shifter element as claimed in claim 8 or 9, wherein at least one of said two opposite edges of the second planar dielectric member is a substantially straight edge.

11. A phase shifter element as claimed in any one of the preceding claims, wherein at least part of the or each conductive track is folded in a serpentine configuration.

12. A phase shifter element as claimed in any one of the preceding claims, wherein said pattern of conductive track(s) is arranged to form three paths comprising two outer paths and a central path, said three paths having a common signal input means at one end thereof and respective output means at the other end thereof.

13. An antenna array including a phase shifter element claimed in any one of the preceding claims.

14. A phase shifter element, substantially as herein described with reference to FIGS. 1 to 8 of the accompanying drawings.
